(19) United States
(12) Patent Application Publication
(10) Pub. No.: US 2017/0288862 A1
(43) Pub. Date: Oct. 5, 2017

(54) SECURELY EXCHANGING LISTS OF VALUES WITHOUT REVEALING THEIR FULL CONTENT

(71) Applicant: Ubimo Ltd., Tel-Aviv (IL)

(72) Inventors: Oded PONCZ, Tel-Aviv (IL); Ran BEN-YAIR, Brooklyn, NY (US)

(21) Appl. No.: 15/472,388

(22) Filed: Mar. 29, 2017

Related U.S. Application Data
(60) Provisional application No. 62/315,892, filed on Mar. 31, 2016.

(51) Int. Cl. H04L 9/06; G06F 21/62; G06Q 30/02; G06F 21/60; G06N 7/00; G06F 17/30; H04L 29/06

(52) U.S. Cl. CPC H04L 9/0643; G06F 17/30864; G06F 21/6245; H04L 63/0428; G06F 21/602; G06N 7/005; G06Q 30/0269

(57) ABSTRACT

A computer implemented method of providing an encrypted executable object containing data values, comprising receiving a query defined by one or more query parameters, obtaining a plurality of data values complying with the query parameter(s), creating an encrypted executable object comprising the plurality of data values where each of the plurality of data values is accessible in the encrypted executable object using the respective data value as an encryption key and providing the encrypted executable object which indicates, in response to an access with one or more questioning data values such the plurality of data values serving as the encryption key, presence or absence of the one or more questioning data values in the encrypted executable object according to the encryption key.

### RELATED APPLICATION(S)

This application claims the benefit of priority under 35 USC 119(e) of U.S. Provisional Patent Application No. 62/315,892, filed on Mar. 31, 2016, the contents of which are incorporated herein by reference in their entirety.

### FIELD AND BACKGROUND OF THE INVENTION

The present invention, in some embodiments thereof, relates to exchanging data values and, more particularly, but not exclusively, to exchanging encrypted executable objects which may be queried for existence of certain data values in the encrypted executable objects.

Data sharing has become a major building block in constructing efficient systems, platforms and/or services.

However data sharing may present major challenges to the sharing parties due to two conflicting needs. At one hand the data sharing parties may want to protect the shared data and/or part of it and prevent exposure to the other data sharing parties. On the other hand data sharing may be essential for taking advantage of tools, services, platforms and systems provided by other parties.

### SUMMARY OF THE INVENTION

According to a first aspect of the present invention there is provided a computer implemented method of providing an encrypted executable object comprising data values, comprising:
Receiving a query defined by one or more query parameters.
Obtaining a plurality of data values complying with the one or more query parameters.
Creating an encrypted executable object comprising the plurality of data values, each of the plurality of data values is accessible in the encrypted executable object using the each data value as an encryption key.
Providing the encrypted executable object which indicates, in response to an access with one or more questioning data values such the plurality of data values serving as the encryption key, presence or absence of the one or more questioning data values in the encrypted executable object according to the encryption key.

Exchanging the data values encrypted in the encrypted executable object may prevent exposure of the data values' content and/or the number of data values included in the encrypted executable object. The provider of the encrypted executable object may protect his information while taking advantage of services provided by another party by sharing at least partially the data values, i.e. to the extent of information already available to the other party. By restricting the information sharing to data values already known to the query issuing (other) party and only indicating presence or absence of the known data values in the encrypted executable object, the encrypted executable object provider may share some of the data with the other party while protecting the rest of the data values and even the quantity of data values.

According to a second aspect of the present invention there is provided a system for providing an encrypted executable object comprising data values, comprising one or more processors adapted to execute code, the code comprising:
Code instructions to receive a query defined by one or more query parameters.
Code instructions to obtain a plurality of data values complying with the one or more query parameters.
Code instructions to create an encrypted executable object comprising the plurality of data values, each of the plurality of data values is accessible in the encrypted executable object using the each data value as an encryption key.
Code instructions to provide the encrypted executable object which indicates, in response to an access with one or more questioning data values such as the plurality of data values serving as the encryption key, presence or absence of the one or more questioning data values in the encrypted executable object according to the encryption key.

According to a third aspect of the present invention there is provided a computer implemented method of querying an encrypted executable object comprising data values, comprising:
Issuing a query defined by one or more query parameters.
Receiving an encrypted executable object created in response to the query. The encrypted executable object comprising a plurality of data values complying with the one or more query parameters.
Accessing the encrypted executable object with one or more questioning data values such as the plurality of data values. The one or more questioning data values serve as an encryption key.
Receiving an indication of presence or absence of the one or more questioning data values in the encrypted executable object according to the encryption key.

According to a fourth aspect of the present invention there is provided a system for querying an encrypted executable object comprising data values, comprising one or more processors adapted to execute code, the code comprising:
Code instructions to issue a query defined by one or more query parameters.
Code instructions to receive an encrypted executable object created in response to the query. The encrypted executable object comprising a plurality of data values complying with the one or more query parameters.
Code instructions to access the encrypted executable object with one or more questioning data values such as the plurality of data values. The one or more questioning data values serve as an encryption key.
Code instructions to receive an indication of presence or absence of the one or more questioning data values in the encrypted executable object according to the encryption key.

According to a fifth aspect of the present invention there is provided a computer implemented method of providing an encrypted dataset comprising data values, comprising:
Receiving a query defined by one or more query parameters.
Obtaining a plurality of data values complying with the one or more query parameters.
Creating an encrypted dataset comprising the plurality of data values. Each of the plurality of data values is encrypted using the each data value as an encryption key.
Providing the encrypted dataset, which using a decryption tool, indicates, in response to an access with one or more questioning data values such as the plurality of data values serving as the encryption key, presence or absence of the one or more questioning data values in the encrypted dataset according to the encryption key.

Exchanging the data values encrypted in the encrypted dataset may prevent exposure of the data values' content and/or the number of data values included in the encrypted dataset. The provider of the encrypted dataset may protect his information while taking advantage of services provided by another party by sharing at least partially the data values, i.e. to the extent of information already available to the other party. By restricting the information sharing to data values already known to the query issuing (other) party and only indicating presence or absence of the known data values in the encrypted dataset, the encrypted dataset provider may share some of the data with the other party while protecting the rest of the data values and even the quantity of data values.

According to a sixth aspect of the present invention there is provided a computer implemented method of querying an encrypted dataset comprising data values, comprising:
Issuing a query defined by one or more query parameters.
Receiving an encrypted dataset created in response to the query. The encrypted dataset comprising a plurality of data values complying with the one or more query parameters.
Accessing, using a decryption tool, the encrypted dataset with one or more questioning data values such as the plurality of data values, the one or more questioning data value serve as an encryption key.
Receiving, using the decryption tool, an indication of presence or absence of the one or more questioning data values in the encrypted dataset according to the encryption key.

In a further implementation form of the first, second, third and/or fourth aspects, the encrypted executable object encrypts a probabilistic structure holding the plurality of data values and indicating a match or a no-match of the one or more questioning data values with one of the plurality of data values. The probabilistic structure may significantly reduce the size, in terms of memory capacity, i.e. memory footprint, of the executable object.

In a further implementation form of the fifth and/or sixth aspects, the encrypted dataset is a probabilistic structure which indicates a match or a no-match of the one or more questioning data values with one of the plurality of data values. The probabilistic structure may significantly reduce the memory footprint of the encrypted dataset

In a further implementation form of the first, second, third, fourth, fifth and/or sixth aspects, the probabilistic structure is encrypted using a set of hash functions such that each of the plurality of data values is used as the encryption key for accessing a respective one of the plurality of data values. A false positive accuracy of the probabilistic structure is set by adjusting one or more attributes of the set, the one or more attributes is a member of a group consisting of: a type of hash functions and a number of hash functions. Encrypting the probabilistic structure by selecting the type and/or number of the hash values may provide flexibility in controlling the memory footprint of the executable object and/or the encrypted dataset, i.e. increased or decreased. Controlling the accuracy of the probabilistic structure in terms of false positive events through the selected set of hash functions may also provide some level of obscurity to prevent an accurate estimation of the content and/or number of the data values contained in the executable object and/or the encrypted dataset.

In a further implementation form of the first, second, third, fourth, fifth and/or sixth aspects, the probabilistic structure is a Bloom filter. The Bloom filter is a model which presents high reliability, integrity and performance thus making it a good probabilistic model implementation for the executable object and/or the encrypted dataset.

In an optional implementation form of the first, second, third, fourth, fifth and/or sixth aspects, the encrypted executable object is created in advance in response to a simulated query such as the query. This may allow the provider of the encrypted executable object and/or the encrypted dataset to encrypt in advance a list of values that may be later accessed by one or more requesters to check for presence or absence of one or more known values (questioning values) in the encrypted executable object and/or the encrypted dataset. This may expedite the process by avoiding the need for online query issue to initiate creation and reception of the encrypted executable object and/or the encrypted dataset.

In a further implementation form of the fifth and/or sixth aspects, the decryption tool utilizes a set of hash functions used to encrypt the encrypted dataset such that each of the plurality of data values is used as the encryption key. This may allow a complete and easy to apply, use and/or deploy solution in which the encrypted dataset is accessed using an available description tool.

In a further implementation form of the fifth and/or sixth aspects, the decryption tool is constructed by a requester issuing the query according to encryption implementation information provided with the encrypted dataset. Providing the decryption tool may allow for easy implementation and/or deployment of the solution for the requester party(s) accessing the encrypted dataset which may be relieved from developing and/or integrating the decryption tool thus reducing development and/or integration costs.

In a further implementation form of the fifth and/or sixth aspects, the decryption tool is provided with the encrypted dataset to a requester issuing the query with the encrypted dataset. This may allow the requester party(s) accessing the encrypted dataset to adapt, develop, alter and/or integrate the decryption tool according to the environment, system, platform, product and/or the like of the requester party(s).

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data.

Optionally, a network connection is provided as well. A display and/or a user input device such as a keyboard or mouse are optionally provided as well.

### BRIEF DESCRIPTION OF THE SEVERAL VIEWS OF THE DRAWING(S)

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a flowchart of an exemplary process of providing an encrypted executable object comprising a plurality of data values complying with query parameters defining a received query, according to some embodiments of the present invention;

FIG. 2 is a schematic illustration of an exemplary system for exchanging encrypted data records comprising a plurality of data values without exposing the data record contents, according to some embodiments of the present invention;

FIG. 3 is a flowchart of an exemplary process of querying an encrypted executable object comprising a plurality of data values, according to some embodiments of the present invention; and

FIG. 4 is a schematic illustration of an exemplary flow of an exemplary use case of exchanging encrypted data records comprising a plurality of data values without exposing the data record contents, according to some embodiments of the present invention.

### DESCRIPTION OF SPECIFIC EMBODIMENTS OF THE INVENTION

The present invention, in some embodiments thereof, relates to exchanging data values and, more particularly, but not exclusively, to exchanging encrypted executable objects which may be queried for existence of certain data values in the encrypted executable objects.

According to some embodiments of the present invention, there are provided methods, systems and computer program products for exchanging data values between users without exposing the data values themselves by creating an encrypted executable object in response to a query and allowing interaction with the encrypted executable object to check for presence or absence of one or more questioning data value in the encrypted executable object. The query issued by a requester (typically a first party) may include one or more query parameters to describe the requested data values. In response to the query, a provider (typically a second party) may create an encrypted executable object which comprises a plurality of data values complying with the query parameter(s). The data values are encrypted (encoded) in the encrypted executable object such that each certain data value serves (is used) as an encryption key for accessing the certain data value. The encrypted executable object may be generated as a standalone encrypted executable object that may be executed such that the requester may interact with the encrypted executable object to access (decode) the encrypted (encoded) data values. Optionally, the encrypted executable object is an encrypted dataset that is coupled with an executable decryption tool implementing the same encoding implementation for decrypting (decoding) the encrypted dataset. Information about the encoding implementation may be provided by the provider to the requester to allow the requester to construct the decryption tool. After receiving the encrypted executable object, the requester may interact with the encrypted executable object to check whether one or more questioning data values are present or absent (match/no-match) in the encrypted executable object. The questioning data value(s) are of the same type as the data values contained in the encrypted executable object and are typically available in advance to the requester who wishes to check whether the “known” questioning data value(s) are present in the encrypted executable object. Since during the creation of the encrypted executable object, each of the data values is used as the encryption key for itself, each of the questioning data value(s) may serve as the encryption (or in practice a decryption key) for accessing a corresponding (equal) data value present in the encrypted executable object. By responding to the requester with presence/absence indication, no data values are exposed to the requester except from data that was already in the possession of the requester, i.e. the questioning data value(s).

Optionally, the encrypted executable object implements a probabilistic structure, for example a Bloom filter constructed using a set of hash functions.

Optionally, an accuracy level (or noise) is controlled by adjusting one or more attributes of the set of hash functions, for example, the type of the selected hash functions, the number of the selected hash functions and/or the like.

Optionally, the encrypted executable object is created in advance according to a simulated query.

Exchanging the data values without exposing their contents may present significant advantages and benefits compared to existing methods for data sharing. First, by encrypting the data values in the encrypted executable object the party providing the encrypted executable object may protect its information. However, the party providing the encrypted executable object would like one or more other parties (requesters) to take advantage of the data values contained in the encrypted executable object as long as the requester(s) are looking for specific data value(s) already available (known) to the requester(s). Thus no information previously unknown to the requester is exposed through the encrypted executable object, i.e. no data values are exposed and not he number of data values contained in the encrypted executable object.

Moreover, using the probabilistic structure, the size, in terms of memory capacity, i.e. memory footprint, of the executable object and/or the encrypted dataset may be significantly reduced thus reducing requirements for one or more resources, for example, storage resources, network bandwidth resources and/or the like. Encrypting the probabilistic structure by selecting the type and/or number of the hash values may allow for further flexibility in controlling the memory footprint of the executable object and/or the encrypted dataset may be controlled, i.e. increased or decreased according to availability of the resource(s). Controlling the accuracy of the probabilistic structure in terms of false positive events through the selected set of hash functions may also provide some level of obscurity to prevent an accurate estimation of the content and/or number of the data values contained in the executable object and/or the encrypted dataset.

Furthermore, in particular when the data values involve private information of users, preventing exposure of the data values may significantly increase privacy protection for the users.

In addition, in case of time/location based applications, for example, advertisement applications, the privacy of the users may be protected even from the advertisers. While the advertisers may have some private details of the users, for example, a client terminal identification (ID), an IP address and/or the like, the advertisers may not be able to track a geographical location of the users. This may be achieved by isolating the advertisers from specific location details of the users. Users that are already known to the advertisers may be identified (by accessing the encrypted executable object created by the advertiser(s)) in terms of, for example, time/location/activity and the ADs (advertisements) content may be presented to the identified users according to their time/location/activity characteristics as defined by the advertiser(s) without the advertiser(s) being aware of the identity of users is presented with the ADs content.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages.

The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network

(LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

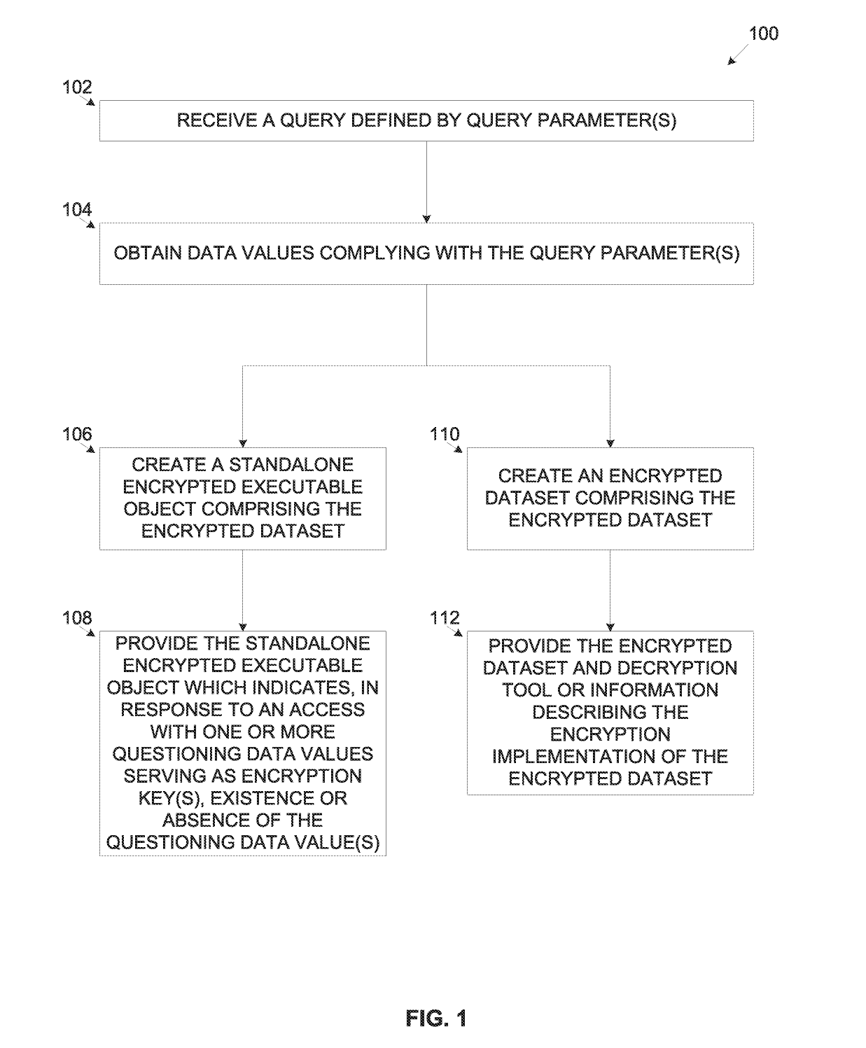

Referring now to the drawings, FIG. 1 illustrates a flowchart of an exemplary process of providing an encrypted executable object comprising a plurality of data values complying with query parameters defining a received query, according to some embodiments of the present invention. A process 100 may be executed to provide, in response to a query from a requester, an encrypted executable object comprising a plurality of data values. The query may be defined by one or more query parameters characterizing the desired data values. The encrypted executable object is constructed by obtaining a plurality of data values complying with the query parameter(s) and encrypting the data values. The plurality of data values may be retrieved, for example, from a data record, for example, a database, a list, a table and/or the like. The data values may further be collected in real time from one or more services, applications, systems and/or the like. In some embodiments of the present invention, the encrypted executable object may be a standalone encrypted executable object, for example, an application, a tool, an agent, a function, a script and/or the like that may be executed to interact with a requester querying an existence of certain one or more data values in the encrypted executable object. In some embodiments of the present invention, the encrypted executable object may be an encrypted dataset, for example, a file, a list, a table, a database and/or the like that is coupled with an executable decryption tool for accessing the encrypted dataset to check for existence of the certain data value(s) in the encrypted dataset. The requester accessing the encrypted executable object to check a presence of one or more certain data values in the encrypted executable object may use the certain data value(s) as the encryption key. Thus the encrypted executable object allows the requester to determine a presence of the certain values which are already available (known) to the requester in advance while not exposing any other data values present in the encrypted executable object and/or the number of the data values.

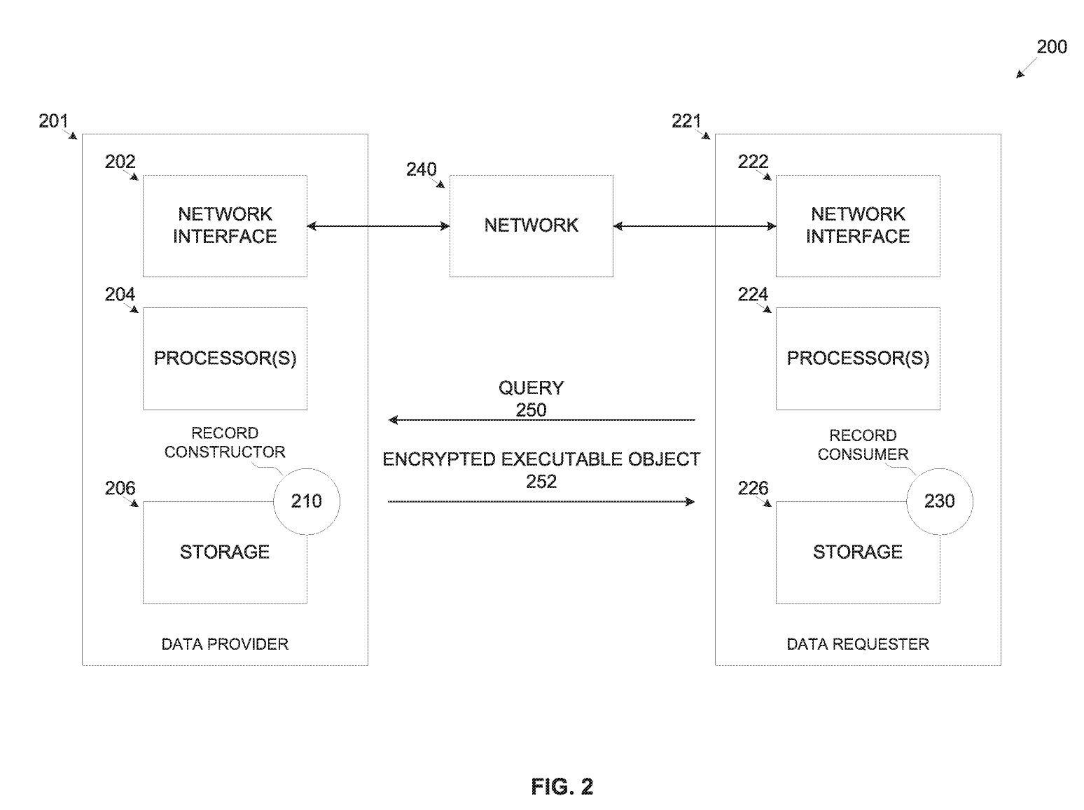

Reference is also made to FIG. 2, which is a schematic illustration of an exemplary system for exchanging encrypted data records comprising a plurality of data values without exposing the data record contents, according to some embodiments of the present invention. An exemplary system 200 may for executing a process such as the process 100 comprises a data provider 201 and a data requester 222 which may communicate with each other over one or more networks 240. Each of the data provider 201 and a data requester 222 may include one or more computing nodes, for example, a computer, a server, a cluster of computing nodes, a cloud computing service and/or the like.

The data provider 201 may include a network interface 202, a processor(s) 204 and a storage 206. The network interface 202 may provide one or more network interfaces, wired and/or wireless for connecting to the network(s) 240, for example, a Local Area Network (LAN), a Wide Area Network (WAN), a Metropolitan Area Network (MAN), a cellular network and/or the like. The processor(s) 204, homogenous or heterogeneous, may be arranged for parallel processing, as clusters and/or as one or more multi core processor(s). The storage 206 may include one or more non-transitory persistent storage devices, for example, a hard drive disk (HDD), a Solid State Disk (SSD) a Flash array and/or the like. The storage 206 may also include one or more networked storage resources accessible over the network(s) 240, for example, a Network Attached Storage (NAS), a storage server, a cloud storage and/or the like. The storage 206 may further utilize one or more volatile memory devices, for example, a Random Access Memory (RAM) device and/or the like for temporary storage of code and/or data.

The processor(s) 204 may execute one or more software modules, for example, a process, a script, an application, an agent, a utility and/or the like which comprise a plurality of program instructions stored in a non-transitory medium such as the storage 206.

The data requester 221 may include a network interface 222 such as the network interface 202, a processor(s) 224 such as the processor(s) 204 and a storage 226 such as the storage 206.

The processor(s) 204 may execute a record constructor 210 comprising one or more software modules for creating an encrypted executable object 252 in response to a received query 250. Optionally, the record constructor 210 is a networked service, for example, Software as a Service (SaaS), Platform as a Service (PaaS), a cloud service and/or the like.

The processor(s) 224 may execute a record consumer 230 comprising one or more software modules for issuing the query 250 requesting the encrypted executable object 252 checking for existence or absence of one or more questioning data values in the encrypted executable object. The questioning data value(s) are naturally of the same type as the data values contained in the encrypted executable object 252 and are “known” (in advance), i.e. available to the record consumer 230.

Optionally, the record constructor 210 and the record consumer 230 are executed on the same device, for example, the data provider 201 or the data requester 222.

As shown at 102, the process 100 starts with the record constructor 210 receiving the query 250 from the record consumer 230. The query 250 is defined by one or more query parameters which describe characteristics, attributes and/or conditions of the data values the record consumer 230 requires. For example, assuming, the record consumer 230 requires data values relating to identification (ID) of the users' client terminals ‘(e.g. computer, laptop, Smartphone, tablet, etc.), the query parameter(s) may define, for example, client terminals of all customers of a certain vendor, client devices of users who registered for a certain website, application and/or service, client terminals of users who downloaded a certain application, client terminals of users living in a certain geographical location and/or the like. The record consumer 230 expects to receive a list of one or more IDs of client terminals complying with the query parameter(s). In another example, assuming, the record consumer 230 requires data values relating to Internet Protocol (IP) addresses of users’ client terminals, the query parameter(s) may define, for example, client terminals of users that visited a certain website during a recent predefined period of time, client terminals which executed a certain application, client terminals of users that logged in to the internet in a certain geographical location and/or the like. The record consumer 230 expects to receive a list of one or more IP addresses of client terminals complying with the query parameter(s). In another example, assuming, the record consumer 230 requires data values relating to IP addresses of fraudulent servers which were detected in the past to be the origin of a malicious attack, the query parameter(s) may define, known for example, fraudulent servers and/or the like. The record consumer 230 expects to receive a list of IP addresses of one or more fraudulent servers detected in the past.

As shown at 104, the record constructor 210 obtains a plurality of data values that comply with the query parameter(s). The record constructor 210 may retrieve the data values from a data record, for example, a database, a list, a table, a structure and/or the like. Additionally and/or alternatively the record constructor 210 may obtain the data values from one or more services, applications and/or the like that collect the data values.

In some embodiments of the present invention, the encrypted executable object 252 is a standalone encrypted executable object created by the record constructor 210. The encrypted executable object 252 may be executed to interact with the record consumer 230.

As shown at 106, the record constructor 210 creates the standalone encrypted executable object, for example, an application, a tool, an agent, a function, a script and/or the like that comprise the obtained data values complying with the query parameter(s). The record constructor 210 may use one or more methods, techniques and/or algorithms as known in the art to create the encrypted executable object. For example, the record constructor 210 may encrypt the data values using a set of hash functions to create an encrypted dataset, for example, a bitmap record and or the like that projects the data values. In particular the record constructor 210 may construct the encrypted dataset as a probabilistic structure, for example, a Bloom Filter that allows matching of one or more questioning data values with each of the data values encrypted in the encrypted dataset to detect a presence and/or an absence of the questioning data value(s) in the encrypted dataset. The Bloom filter probabilistic structure may be used due to the fact that while it allows some false positive matches are possible (as defined by the accuracy of the Bloom filter probabilistic structure), false negative matches may not occur. False positive is defined as indicating a no-match for a data value that is present in the encrypted dataset and false negative is defined as indicating a match for a data value that is not present (i.e. absent) in the encrypted dataset.

Optionally, the record constructor 210 may adjust one or more attributes of the set of the hash functions, for example, a type of the selected hash functions, a number of the selected hash functions and/or the like to set a desired false positive accuracy of the encrypted dataset probabilistic structure as known in the art. The false positive accuracy of the probabilistic structure defines the probability for a false positive match.

The record constructor 210 may create the encrypted dataset such that each of the data values contained in the encrypted dataset serves as an encryption key for encoding it. The same encryption key (i.e. the data value itself) used to encode each data value, may later be used to access (decrypt and/or decode) the respective data value from the encrypted dataset.

The record constructor 210 may then encapsulate the encrypted dataset as known in the art to create the standalone encrypted executable object. The encapsulation may include integrating the encrypted dataset into an application, an agent, a tool, a script and or the like that may be executed to interact with the record consumer 230. The encapsulation facilitates receiving one or more questioning data values from the record consumer 230 and searching for them in the encrypted structure encapsulated in the standalone encrypted executable object. As the standalone encrypted executable object is provided by the record constructor 210, the standalone encrypted executable object may be adapted to access (decrypt or encode) the encrypted dataset using the same set of hash functions used to encrypt and/or encode the encrypted dataset.

As shown at 108, the record constructor 210 provides the standalone encrypted executable object to the record consumer 230. The record consumer 230 may then interact with the standalone encrypted executable object executed by the processor(s) 224 to access the encrypted dataset contained in the standalone encrypted executable object to check for a presence or absence of a questioning data value available (in advance) to the record consumer 230.

In some embodiments of the present invention, the encrypted executable object 252 comprises the encrypted dataset itself, for example, a file, a list, a table, a database and/or the like coupled with an executable decryption tool.

As shown at 110, the record constructor 210 creates the encrypted dataset as described herein above in step 106.

As shown at 112, the record constructor 210 provides the encrypted dataset to the record consumer 230. In order to allow the record consumer 230 to construct the decryption tool for accessing (decrypting) the encrypted dataset, the record constructor 210 may provide the record consumer 230 information of the encrypted dataset encryption and/or encoding implementation, for example, a description of the set of the hash functions used to encode the encrypted dataset. Using the received encryption implementation, for example, the set of hash functions, the record consumer 230 may construct the decryption tool to submit (access) one or more questioning data values (which are available to the record consumer 230) to check for a match (presence or absence) of the questioning data value(s) in the encrypted dataset. When accessing the encrypted dataset, the record consumer 230 uses the questioning data value(s) themselves as the encryption key for decrypting the respective data value(s). For example, assuming, the record consumer 230 issued the query 250 to obtain data values relating to ID of the user terminals of users that registered for a certain website, application and/or service. In such case, the questioning data value(s) may include for, example, ID of the user terminals that are currently online, ID of user terminals that are currently executing and/or logged into the certain website, application and/or service, ID of user terminals of users currently located in a certain geographical location, ID of user terminals of users currently participating in an event (defining geographical location and time) and/or the like. In another example, assuming, the record consumer 230 issued the query 250 to obtain data values relating to IP addresses of users' client terminals visited a certain website in the past. In such case, the questioning data value(s) may include for, example, IP of currently online client terminals, IP of client terminals visiting a certain website, client terminals executing a certain application, presence of client terminals in a certain geographical location, presence of client terminals in a certain event (defining time and geographical location) and/or the like. In another example, assuming, assuming, the record consumer 230 issued the query 250 to obtain data values relating to IP addresses of fraudulent servers which were detected in the past to be the origin of a malicious attack. In such case, the questioning data value(s) may include for, example, an IP of a server currently detected as a potential source of a malicious attack.

Optionally, the record constructor 210 provides the decryption tool to the record consumer 230 that may initiate execution of the decryption tool to access the encrypted dataset. As the record constructor 210 provides and/or creates the decryption tool and the record constructor 210 is familiar with the encoding implementation, the appropriate encoding implementation may be embedded in the decryption tool, for example, the set of hash functions used to encode the encrypted dataset.

Optionally, the record constructor 210 creates the encrypted executable object 252 in advance using the plurality of data values collected in advance, according to the one or more query parameters of a simulated query such as the query 250. This may allow the record consumer 230 to have the encrypted executable object 252 created in advance and available for accesses to check for a match (presence or absence) of the questioning data value(s) in real time. For example, a certain record provider 130, for example, a product and/or service vendor, may define a certain simulated query defined by query parameters which define to, for example, ID of client terminals of all customers who visited a certain website and/or a store of the vendor in the past year.

According to the simulated query, the record constructor 210 may collect a list of the client terminals' ID of all customers complying with the query parameters. The record consumer 230 may thus have the encrypted executable object 252 provided by the vendor in advance such that the record consumer 230 may immediately access the encrypted executable object 252 with relevant questioning data value(s) avoiding the need to issue the query 250.

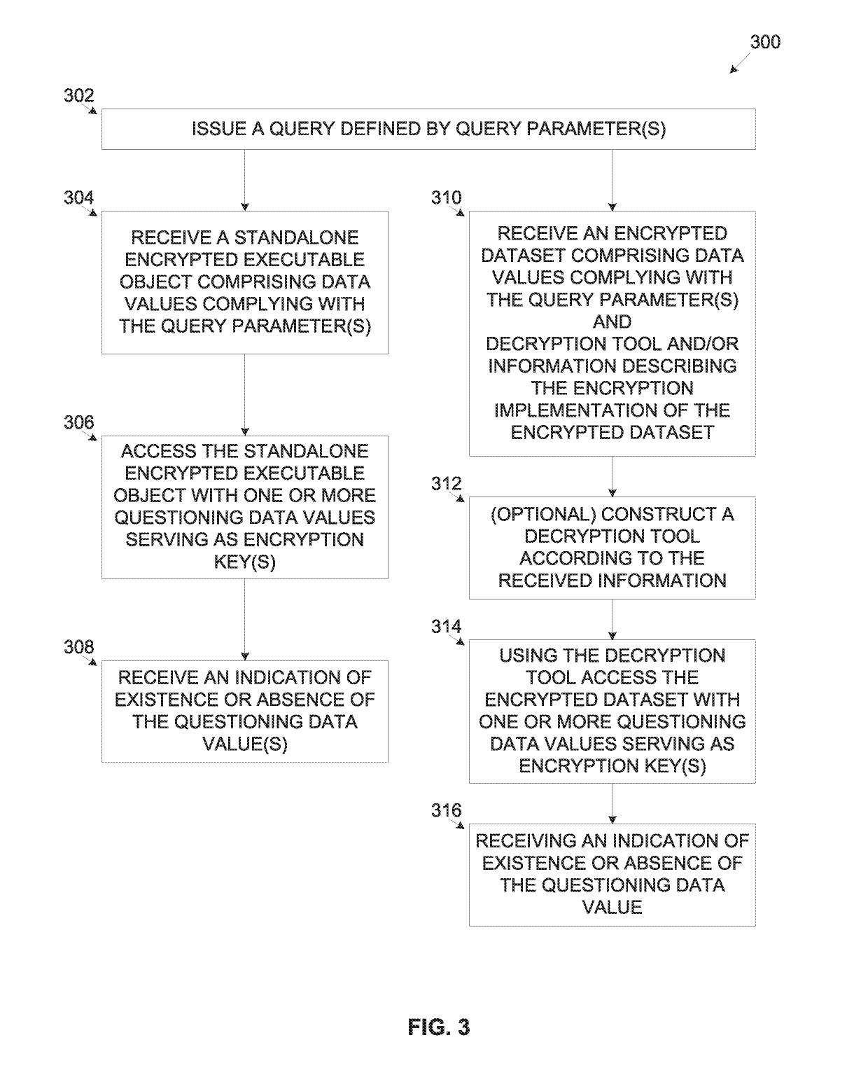

Reference is now made to FIG. 3, which is a flowchart of an exemplary process of querying an encrypted executable object comprising a plurality of data values, according to some embodiments of the present invention. A process 300 may be executed in a system such as the system 200 by a record consumer such as the record consumer 230 to issue a query such as the query 250 for an encrypted executable object such as the encrypted executable object 252.

As shown at 302, the process 300 starts with the record consumer 230 issuing the query 250 defined by the query parameter(s) to a record constructor such as the record constructor 210.

As discussed before, in some embodiments of the present invention, the encrypted executable object 252 is the standalone encrypted executable object created by the record constructor 210.

As shown in 304, the record consumer 230 receives the encrypted executable object 252, for example, the standalone encrypted executable object from the record constructor 210. The encrypted executable object comprises the plurality of data values complying with the query parameter(s) of the query 250.

As shown in 306, since the standalone encrypted executable object may be executed, for example, by a processor(s) such as the processor(s) 224, the record consumer 230 may instruct launching the encrypted executable object. The record consumer 230 interacts with the encrypted executable object to submit an access request for matching one or more questioning data values to check for presence or absence of the questioning data value(s) in the encrypted executable object. The questioning data value(s) are naturally of the same type as the data values contained in the encrypted executable object and are available to the record consumer 230, i.e. known in advance.

As shown at 308, for each of the questioning data value(s), the encrypted executable object responds to the record consumer 230 with an indication of match in case the questioning data value is present in the standalone encrypted executable object or a no-match in case the questioning data value is not present (absent) in the standalone encrypted executable object.

Similarly to the process 100, in some embodiments of the present invention, the encrypted executable object 252 is the encrypted dataset itself created by the record constructor 210 which is coupled with the decryption tool for accessing it.

As shown in 310, the record consumer 230 receives the encrypted executable object 252, i.e. the encrypted dataset from the record constructor 210. The encrypted dataset includes the plurality of data values complying with the query parameter(s) of the query 250. The record consumer 230 may further receive from the record constructor 210 information of the encrypted dataset encryption and/or encoding implementation, for example, the description of the set of the hash functions used to encode the encrypted dataset. Optionally, the record consumer 230 receives from the record constructor 210 the decryption tool for accessing the encrypted dataset.

As shown at 312 which is an optional step, the record consumer 230 constructs the decryption tool according to the encrypted dataset encryption and/or encoding implementation information received from the record constructor 210.

As shown at 314, the record consumer 230, using the decryption tool, may access the encrypted dataset to check for presence or absence of the questioning data value(s) in the encrypted dataset.

As shown at 316, for each of the questioning data value(s), the record consumer 230 receives through the decryption tool an indication of a match (i.e. presence) or a no-match (absence) of the respective questioning data value in the encrypted dataset.

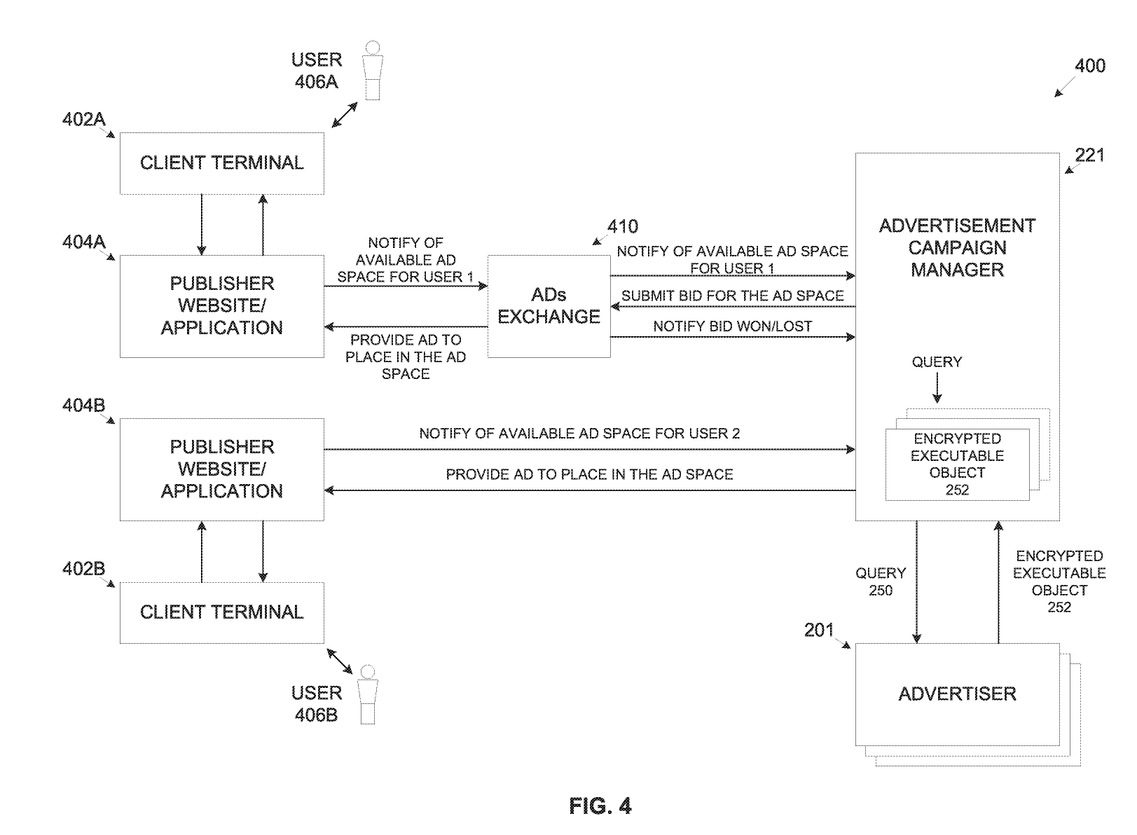

Reference is now made to FIG. 4, which is a schematic illustration of an exemplary flow of an exemplary use case of exchanging encrypted data records comprising a plurality of data values without exposing the data record contents, according to some embodiments of the present invention.

The process 100 coupled with the process 300 may be used for a plurality of applications in which users (typically vendors, service providers and/or the like) want to share information with each other while exposing only the absolute necessary information in order, for example, to protect business information, to protect user privacy, to maintain a commercial advantage and/or the like.

Such applications may include, for example, security applications, advertising applications, promotion applications and/or the like.

For example, a security application may detect a suspected malicious attack originating from a certain IP address. The security application may issue a query such as the query 250 to a service of another vendor requesting information on IP addresses (i.e. the data values) which have been detected in the past to launch malicious attacks having attack vectors, patterns and/or the like as detected in the suspected malicious attack. In response, the service of the other vendor may provide an encrypted executable object such as the encrypted executable object 252 comprising a plurality of IP addresses from which similar malicious attacks originated in the past. The security application may then access the received encrypted executable object 252 to check if the certain IP address (being the questioning data value) is present in the encrypted executable object 252. This implementation allows providing the security application with information about the certain IP address without revealing other IP addresses (data values) included in the encrypted executable object 252 thus protecting the information assets of the service vendor.

In another example, a mobile application vendor may want to inquire which user terminals are executing the mobile application at certain times. The mobile application vendor may issue a query such as the query 250 to a service of another vendor requesting information on client terminal IDs of client terminals running the mobile application, for example, at a certain time. In response, the service of the other vendor may provide an encrypted executable object such as the encrypted executable object 252 comprising a plurality of client terminal IDs which execute the mobile application at the certain time. The mobile application vendor may then access the received encrypted executable object 252 to check if certain client terminal IDs he has acquired in the past are present in the encrypted executable object 252. This implementation allows providing the mobile application vendor with information about the client terminal IDs the mobile application vendor is already familiar with without revealing other client terminal IDs included in the encrypted executable object 252 thus maintaining a commercial advantage of the service vendor for example.

The processes 100 and 300 may be of particular benefit for advertisement applications as may be demonstrated through a use case.

Reference is now made to FIG. 4, which is a schematic illustration of an exemplary flow of an exemplary use case of exchanging encrypted data records comprising a plurality of data values without exposing the data record contents, according to some embodiments of the present invention. An exemplary system 400 for managing advertisement campaigns includes one or more client terminals 402, for example, a client terminal 402A used by a user 406A and a client terminal 402B used by a user 406B, one or more publishers, for example, a publisher 404A and a publisher 404B, an advertisement campaign manager being a data requester record such as the data requester 221 and one or more advertisers being record providers such as the record provider 201. The system 400 may further include an ADs (advertisements) exchange 410 in which advertisement spaces (slots) are traded. The publishers 404 may provide content to the users 406, for example, websites which the user(s) 406 may visit using a browser executed by their client terminal(s) 402, a mobile applications executed by the client terminal(s) 402, desktop applications executed by the client terminal(s) 402 and/or the like. The publishers 404 may typically provide AD slots that may be populated with ADs to be presented to the respective users 406 (also known as impressions).

The advertisers 201 may each have a list of IDs of client terminal 402 of users 406. One or more of the advertiser 201 may create, update and/or maintain the list(s) by, for example, monitoring registrations of the users 406, storing and using past purchase information of the users 406 who purchased products and/o services offered at the website and/or application of the advertiser 201, storing and using past historic interaction data of the users 406 during previous advertisement campaign(s), for example, users 406 who viewed videos of the advertiser 201 using the client terminal 402 and/or the like [. The advertisers 201 may further define one or more advertisement criteria through the advertisement campaign manager 221 to efficiently present their ADs to relevant users 406 which may be potential customers for the product and/or service offered through the ADs. The advertisement criteria may include, for example, interaction during a time of day, presence at a geographical location, presence at an event (defining both time and geographical location), interaction with certain published content, and/or the like.

Assuming that one or more of the users 406, for example, the user 406B using the client terminal 402B interacts (uses) with content provided by the publisher 404, for example, a website hosted by the publisher 404B. The publisher 404B may generate a notification to the advertisement campaign manager 221 notifying that one or more AD spaces are available for presenting one or more ADs to the user 406B. The notification may include the ID of the client terminal 402B.

The advertisement campaign manager 221 using a record consumer such as the record consumer 230 may issue a query such as the query 250 to one or more of the advertisers 201 asking for IDs of client terminals. In response, each of the advertisers executing a record constructor such as the record constructor 210 may create one or more encrypted executable objects such as the encrypted executable object 252 comprising their respective lists IDs of client terminal 402.

The advertisement campaign manager 221 using the record consumer 230 may then access one or more of the encrypted executable object 252 to check for a match (presence or absence) of the ID of the client terminal 402B in one or more of the encrypted executable object 252. In case of a match in one or more of the encrypted executable objects 252, the advertisement campaign manager 221 may check the advertisement criteria set by each of the respective advertisers 201 to check if the AD space is appropriate for placing the AD. For example, assuming the advertiser 201 defined an advertisement criterion for presenting a certain AD to users attending a soccer match in UK. In case, for example, the client terminal 402B is detected at the Wembley stadium on a Saturday, 2:00 PM, the advertisement campaign manager 221 may determine that the user 406B complies with the defined advertisement criterion and may be presented with the certain AD. In another example, assuming the advertiser 201 defined an advertisement criterion for presenting a certain AD to users attending rock concert in the US. In case, for example, the client terminal 402B is detected at the Anna is at the Madison Square Garden on Sunday 9 PM which correlates with a U2 concert, the advertisement campaign manager 221 may determine that the user 406B complies with the defined advertisement criterion and may be presented with the certain AD.

After verifying the ID of the client terminal 402B is present in the encrypted executable objects 252 of a certain advertiser 201 and that the advertisement criteria are met, the advertisement campaign manager 221 may send the certain AD to the publisher 404B which presents it to the user 406B.

Optionally, one or more of the advertisers 201 may create the encrypted executable objects 252 in advance such that the encrypted executable objects 252 are available to the advertisement campaign manager 221 for accessing the encrypted executable objects 252 with the questioning data value immediately (avoiding issuing the query 250). This may significantly reduce the response time that may be involved with communicating with the advertiser(s) 201.

In case the ADs allocation is done through the ADs exchange 410, the same process as described herein above is done with the exception that the communication between the publisher(s) 404, for example, the publisher 404A with the advertisement campaign manager 221 is done through the ADs exchange 410. In case one or more of the users 406, for example, the user 406A using the client terminal 402A interacts with the content published by the publisher 404A, the publisher 404A may notify the ADs exchange 410 of the available AD space(s). The ADs exchange 410 in turn may notify the advertisement campaign manager 221 of the available AD space(s). The advertisement campaign manager 221 may conduct the same process as described herein above to determine whether the AD space(s) are appropriate for presenting the AD(s) by checking for a match of the ID of the client terminal 402A in the encrypted executable object 252 of one or more of the advertisers and checking for compliance with the advertisement criteria.

The advertisement campaign manager 221 and the ADs exchange 410 may negotiate a price for placing the AD(s) at the available. In case the negotiation is successful, i.e. a bid submitted by the advertisement campaign manager 221 is accepted, the advertisement campaign manager 221 may forward the respective AD(s) to the ADs exchange 410 which may forward the AD(s) to the publisher 404A.

The implementation of the processes 100 and 300 may present significant benefits. First, the advertisers 404 may protect their commercial information, for example, details of their customer base and while enabling presenting ADs content to users 406 detected in their customer base, the information itself may be protected as it is not exposed to any party other than the advertiser 404 itself. Second, the advertiser(s) 402 themselves are not aware of which of their users 406 is presented with the ADs content. The advertisement campaign manager 212 is the only one that makes the connection between the current time/location/activity of the users 406 and their presence in the customer base of one or more of the advertisers 402. However, since the advertisement campaign manager 212 has no details of the users 406 except for their current time/location/activity, the advertisement campaign manager 212 may not correlate the users 406 with his real identifying details, i.e. name, ID and/or the like. This may significantly increase user privacy for the users 406.

It is expected that during the life of a patent maturing from this application many relevant technologies and/or methodologies will be developed and the scope of the terms data encoding/decoding, data encrypting/decrypting and probabilistic structure are intended to include all such new technologies a priori.

As used herein the term “about” refers to ±10%.

The terms “comprises”, “comprising”, “includes”, “including”, “having” and their conjugates mean “including but not limited to”.

The term “consisting of” means “including and limited to”.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

What is claimed is:

1. A computer implemented method of providing an encrypted executable object comprising data values, comprising:
receiving a query defined by at least one query parameter;
obtaining a plurality of data values complying with said at least one query parameter;
creating an encrypted executable object comprising said plurality of data values, each of said plurality of data values is accessible in said encrypted executable object using said each data value as an encryption key; and
providing said encrypted executable object which indicates, in response to an access with at least one questioning data value such said plurality of data values serving as said encryption key, presence or absence of said at least one questioning data value in said encrypted executable object according to said encryption key.

2. The computer implemented method of claim 1, wherein said encrypted executable object encrypts a probabilistic structure holding said plurality of data values and indicating a match or a no-match of said at least one questioning data value with one of said plurality of data values.

3. The computer implemented method of claim 2, wherein said probabilistic structure is encrypted using a set of hash functions such that each of said plurality of data values is used as said encryption key for accessing a respective one of said plurality of data values, a false positive accuracy of said probabilistic structure is set by adjusting at least one attribute of said set, said at least one attribute is a member of a group consisting of: a type of hash functions and a number of hash functions.

4. The computer implemented method of claim 2, wherein said probabilistic structure is a Bloom filter.

5. The computer implemented method of claim 1, further comprising creating said encrypted executable object in advance in response to a simulated query such as said query.

6. A system for providing an encrypted executable object comprising data values, comprising:
at least one processor adapted to execute code, said code comprising:
code instructions to receive a query defined by at least one query parameter;
code instructions to obtain a plurality of data values complying with said at least one query parameter;
code instructions to create an encrypted executable object comprising the plurality of data values, each of said plurality of data values is accessible in said encrypted executable object using said each data value as an encryption key; and
code instructions to provide said encrypted executable object which indicates, in response to an access with at least one questioning data value such as said plurality of data values serving as said encryption key, presence or absence of said at least one questioning data value in said encrypted executable object according to said encryption key.

7. A computer implemented method of querying an encrypted executable object comprising data values, comprising:
issuing a query defined by at least one query parameter;
receiving an encrypted executable object created in response to said query, said encrypted executable object comprising a plurality of data values complying with said at least one query parameter;
accessing said encrypted executable object with at least one questioning data value such as said plurality of data values, said at least one questioning data value serves as an encryption key; and
receiving an indication of presence or absence of said at least one questioning data value in said encrypted executable object according to said encryption key.

8. A system for querying an encrypted executable object comprising data values, comprising:
at least one processor adapted to execute code, said code comprising:
code instructions to issue a query defined by at least one query parameter;
code instructions to receive an encrypted executable object created in response to said query, said encrypted executable object comprising a plurality of data values complying with said at least one query parameter;
code instructions to access said encrypted executable object with at least one questioning data value such as said plurality of data values, said at least one questioning data value serves as an encryption key; and
code instructions to receive an indication of presence or absence of said at least one questioning data value in said encrypted executable object according to said encryption key.

9. A computer implemented method of providing an encrypted dataset comprising data values, comprising:
receiving a query defined by at least one query parameter;
obtaining a plurality of data values complying with said at least one query parameter;
creating an encrypted dataset comprising said plurality of data values, each of said plurality of data values is encrypted using said each data value as an encryption key; and
providing said encrypted dataset, which using a decryption tool, indicates, in response to an access with at least one questioning data value such as said plurality of data values serving as said encryption key, presence or absence of said at least one questioning data value in said encrypted dataset according to said encryption key.

10. The computer implemented method of claim 9, wherein said encrypted dataset is a probabilistic structure which indicates a match or a no-match of said at least one questioning data value with one of said plurality of data values.

11. The computer implemented method of claim 10, wherein said probabilistic structure is a Bloom filter.

12. The computer implemented method of claim 10, wherein said probabilistic structure is encrypted using a set of hash functions such that each of said plurality of data values is used as said encryption key for accessing a respective one of said plurality of data values, a false positive accuracy of said probabilistic structure is set by adjusting at least one attribute of said set, said at least one attribute is a member of a group consisting of: a type of hash functions and a number of hash functions.

13. The computer implemented method of claim 9, wherein said decryption tool utilizes a set of hash functions used to encrypt said encrypted dataset such that each of said plurality of data values is used as said encryption key.

14. The computer implemented method of claim 9, wherein said decryption tool is constructed by a requester issuing said query according to encryption implementation information provided with said encrypted dataset.

15. The computer implemented method of claim 9, wherein said decryption tool is provided with said encrypted dataset to a requester issuing said query.

16. The computer implemented method of claim 9, further comprising creating said encrypted dataset in advance in response to a simulated query such as said query.

17. A computer implemented method of querying an encrypted dataset comprising data values, comprising:
issuing a query defined by at least one query parameter;
receiving an encrypted dataset created in response to said query, said encrypted dataset comprising a plurality of data values complying with said at least one query parameter;
accessing, using a decryption tool, said encrypted dataset with at least one questioning data value such as said plurality of data values, said at least one questioning data value serves as an encryption key; and
receiving, using said decryption tool, an indication of presence or absence of said at least one questioning data value in said encrypted dataset according to said encryption key.
